(19) United States
(12) Patent Application Publication
(10) Pub. No.: US 2021/0141125 A1
(43) Pub. Date: May 13, 2021

(54) METHOD OF PRODUCING OPTICAL ELEMENT

(71) Applicant: OLYMPUS CORPORATION, Tokyo (JP)

(72) Inventors: Taku NOSE, Tokyo (JP); Ikunori HIROSE, Tokyo (JP)

(73) Assignee: OLYMPUS CORPORATION, Tokyo (JP)

(21) Appl. No.: 17/148,670

(22) Filed: Jan. 14, 2021

Related U.S. Application Data
(63) Continuation of application No. PCT/JP2019/026954, filed on Jul. 8, 2019.

(30) Foreign Application Priority Data
Jul. 20, 2018 (JP) 2018-136456

(51) Int. Cl. G02B 3/00; G02B 1/14; G02B 1/00

(52) U.S. Cl. CPC G02B 3/0031; G02B 1/007; G02B 1/14

(57) ABSTRACT

Provided is a method of producing an optical element. The method includes heating a preform that is made of a fluorophosphate glass material to alter a region including a surface of the preform to form a protection layer; and performing press molding on the preform with the formed protection to form a molded object having an optical element shape.

### CROSS-REFERENCE TO RELATED APPLICATIONS

This application is a continuation of PCT international application No. PCT/JP2019/026954 filed on Jul. 8, 2019, which designates the United States, incorporated herein by reference, and which claims the benefit of priority from Japanese Patent Application No. 2018-136456, filed on Jul. 20, 2018, incorporated herein by reference.

### BACKGROUND

### 1. Technical Field

The present disclosure relates to a method of producing an optical element.

### 2. Related Art

As one of methods for producing an optical element, such as a glass lens, as described in Japanese Laid-open Patent Publication No. 2014-24741 for example, a technique of forming a preform into an optical element shape by heating, softening, and press molding, and thereafter polishing and removing an oxidized layer that is formed on a surface of the optical element has been known.

In production methods including the method described in Japanese Laid-open Patent Publication No. 2014-24741, in some cases, a defect, such as a crack, may occur at the time of press molding depending on the type of a glass material used in the preform.

### SUMMARY

In some embodiments, provided is a method of producing an optical element. The method includes: heating a preform that is made of a fluorophosphate glass material to alter a region including a surface of the preform to form a protection layer; and performing press molding on the preform with the formed protection to form a molded object having an optical element shape.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a flowchart illustrating a sequence of processes of a method of producing an optical element according to an embodiment of the disclosure;

FIG. 2 is a perspective view illustrating a configuration of an annealing furnace that is used in a first annealing process and a second annealing process in the method of producing the optical element according to the embodiment of the disclosure;

FIG. 3 is a cross-sectional view illustrating a configuration of a carriage tray that is used in the first annealing process in the method of producing the optical element according to an embodiment of the disclosure;

FIG. 4 is a cross-sectional view of a configuration of a carriage tray that is used in the second annealing process in the method of producing the optical element according to the embodiment of the disclosure;

FIG. 5 is a cross-sectional view illustrating a preform that is subjected to the first annealing process in the method of producing the optical element according to the embodiment of the disclosure; and

FIG. 6 is a cross-sectional view illustrating a molded object that is subjected to the second annealing process in the method of producing the optical element according to the embodiment of the disclosure.

### DETAILED DESCRIPTION

Embodiments of a method of producing an optical element according to the present disclosure will be described below with reference to the drawings. The disclosure is not limited to the embodiments below, and the constituent elements of the embodiments below include one that can easily be replaced by a person skilled in the art and one that is practically identical.

The method of producing the optical element according to the present embodiment is a method of producing an optical element (for example, a glass lens) by performing press molding on a heated and softened preform (molding material), and includes a first annealing process S1, a pressing process S2, a cooling process S3, a second annealing process S4, a polishing process S5, and a film forming process S6 that are performed in this order as illustrated in FIG. 1.

In the method of producing the optical element according to the present embodiment, a fluorophosphate glass material is used as a material of a preform. It is known that molding of the fluorophosphate glass material is generally difficult and a defect, such as a crack, frequently occurs at the time of press molding. In the method according to the present embodiment, as will be described later, it is possible to prevent a defect, such as a crack, by performing the first annealing process before a pressing process.

In the first annealing process of the method of producing the optical element according to the present embodiment, an annealing process (heating process) is performed by using an annealing furnace 1 as illustrated in FIG. 2 in a state in which a preform M is arranged in a closed space. In the second annealing process of the method of producing the optical element according to the present embodiment, an annealing process (heating process) is performed by using the annealing furnace 1 in a state in which a molded object O having an optical element shape is arranged in the closed space. The annealing furnace 1 is an apparatus that controls temperature in the furnace to eliminate distortion of the molded object O. The annealing furnace 1 includes a stirring fan 11 and a mounting unit 12.

The stirring fan 11 is a device to homogenize the atmosphere in the furnace by stirring air inside the furnace. A housing box 13 is mounted on a mounting unit 12. The housing box 13 includes a housing portion 131 and a cap portion 132. A plurality of (two in the present embodiment) carriage trays 14 are housed in the housing portion 131.

A plurality of recessed portions are formed in each of the carriage trays 14, and the preform M is mounted on each of the recessed portions. Specifically, as illustrated in FIG. 3, a first recessed portion 141 and a second recessed portion 142 are formed in the carriage tray 14. The preform M is mounted on a stepped portion between the first recessed portion 141 and the second recessed portion 142. By performing the annealing process using the carriage tray 14 as described above, it is possible to prevent a defect, such as a scratch, from being generated on the preform M. Meanwhile, the carriage tray 14 is made of metal, such as aluminum or stainless steel.

In the second annealing process, a carriage tray 14A as illustrated in FIG. 4 is used instead of the carriage tray 14. A plurality of recessed portions are formed in the carriage tray 14A, and the molded object O is mounted on each of the recessed portions. Specifically, as illustrated in FIG. 4, a first recessed portion 141A and a second recessed portion 142A are formed on the carriage tray 14A. The molded object O is mounted on a stepped portion between the first recessed portion 141A and the second recessed portion 142A. By performing the annealing process using the carriage tray 14A as described above, it is possible to prevent an external defect, such as a scratch, on an optical functional surface of the molded object O. Meanwhile, the carriage tray 14A is made of metal, such as aluminum or stainless steel.

Here, if the cap portion 132 of the housing box 13 illustrated in FIG. 2 is closed, two closed spaces are formed inside the housing box 13. In other words, as illustrated in FIG. 3, a first closed space Sp1 is formed between a lower surface (first surface) of the preform M and the second recessed portion 142 of the carriage tray 14. Further, as illustrated in FIG. 4, the first closed space Sp1 is formed between a lower surface (first surface) of the molded object O and the second recessed portion 142A of the carriage tray 14A.

Furthermore, as illustrated in FIG. 2, a second closed space Sp2 is formed between an upper surface (second surface) of the preform M and the cap portion 132. Moreover, the same applies to the case in which the carriage tray 14A on which the molded object O is mounted is housed in the housing box 13, so that the second closed space Sp2 is formed between an upper surface (second surface) of the molded object O and the cap portion 132.

It is preferable that the first closed space Sp1 is formed as a space with a volume of 10 mm\hat{ }3 or smaller per surface area of 1 mm\hat{ }2 of each of the lower surface of the preform M and the lower surface of the molded object O. By setting the volume of the first closed space Sp1 as described above, it is possible to limit an amount of oxygen that reacts with the upper and lower surfaces of the preform M. With this configuration, it is possible to slow down a formation rate of a protection layer (see FIG. 5) that is formed on the surface of the preform M in the first annealing process and it is possible to slowly form the protection layer, so that it becomes possible to easily set a thickness of the protection layer to a desired thickness. Meanwhile, a lower limit of the volume of the first closed space Sp1 that comes into contact with the lower surface of the preform M can be experimentally obtained depending on the desired thickness of the protection layer. Further, there is no lower limit of the volume of the first closed space Sp1 that comes into contact with the lower surface of the molded object O, and, for example, the volume may be set to zero.

Furthermore, it is preferable that the second closed space Sp2 is formed as a space with a volume of 600 mm\hat{ }3 or smaller per surface area of 1 mm\hat{ }2 of each of the upper surface of the preform M and the upper surface of the molded object O. By setting the volume of the second closed space Sp2 as described above, it is possible to limit an amount of oxygen that reacts with the upper and lower surfaces of the molded object O. With this configuration, it is possible to slow down a formation rate of an altered layer (see FIG. 6) that is formed on the surface of the molded object O in the second annealing process and it is possible to slowly form the altered layer, so that it becomes possible to easily set a thickness of the altered layer to a desired thickness. Meanwhile, a lower limit of the volume of the second closed space Sp2 that comes into contact with each of the lower surface of the preform M and the lower surface of the molded object O can be experimentally obtained depending on the desired thickness of the altered layer.

Each of the processes of the method of producing the optical element according to the present embodiment will be described in detail below.

First Annealing Process S1

The first annealing process is a process of forming a protection layer in a region including the surfaces of the preforms M. In this process, the plurality of preforms M are mounted on the carriage tray 14, the carriage tray 14 is housed in the housing portion 131 of the housing box 13, and thereafter the cap portion 132 is closed. Accordingly, the first closed space Sp1 is formed below each of the preforms M and the second closed space Sp2 is formed above the plurality of preforms M. Then, an annealing process is performed by heating the preforms M in the housing box 13 to predetermined temperature (for example, 430±5 degrees Celsius).

In the first annealing process, the preforms M are heated in an air atmosphere and the region including the surfaces of the preforms M is altered, so that a protection layer M2 is formed on an outer side of a standard layer M1 that is made of a normal glass component as illustrated in FIG. 5. The protection layer M2 is an oxidized layer that is obtained by oxidization and alteration of the glass component near the surfaces of the preforms M. The protection layer M2 contains, for example, 30% or less fluorine and 30% or more oxygen. Further, it is preferable to set a thickness of the protection layer M2 to 0.06 micrometer (μm) to 0.1 μm, and, it is possible to form the protection layer M2 with a thickness in the above-described range by increasing temperature to a set temperature (for example, 430±5 degrees Celsius) in an hour, maintaining the set temperature for 10 minutes, and performing rapid cooling.

The first annealing process is performed such that, as described above, “the volume of the first closed space Sp1<the volume of the second closed space Sp2”. Therefore, one of two surfaces of the preform M, on which the protection layer M2 is to be thinly formed, is arranged at the side of the first closed space Sp1, and another surface, on which the protection layer M2 is to be thickly formed, is arranged at the side of the second closed space Sp2.

In the first annealing process, the lower surface of the preform M reacts with only oxygen in the first closed space Sp1, and the upper surface of the preform M reacts with only oxygen in the second closed space Sp2. Therefore, as compared to a conventional method in which, for example, the preform M is subjected to the annealing process in the annealing furnace 1 without being housed in the housing box 13, it is possible to slow down the formation rate of the protection layer M2. Consequently, it is possible to prevent the protection layer M2 from becoming unnecessarily thick, and it is possible to form the protection layer M2 with a minimum and desired thickness.

Pressing Process S2

In the pressing process, the preform M on which the protection layer M2 is formed by the annealing process is arranged on a forming mold, is further heated at predetermined temperature (for example, 600 degrees Celsius), and is subjected to press molding, so that the molded object O having an optical element shape is formed.

Cooling Process S3

In the cooling process, the molded object O subjected to the press molding is cooled at predetermined temperature, and thereafter demolding is performed by removing the molded object O from the forming mold.

Here, fluorine contained in the fluorophosphate glass material has property of easily and tightly adhering to a film material of the forming mold. Therefore, in the conventional technique, if a preform made of the fluorophosphate glass material is subjected to press molding, the preform strongly adheres to the forming mold. Accordingly, when the preform is removed from the forming mold in the cooling process, contraction of the preform is prevented by the forming mold, a breaking power is generated on the preform due to contraction inside the preform and an adhesion force of the surface of the preform, and a crack frequently occurs.

In contrast, in the method of producing the optical element according to the present embodiment, the first annealing process is performed before the pressing process, so that fluorine is removed from the surface (surface layer) of the preform M and oxygen is incorporated instead, so that the protection layer M2 containing plenty of oxygen is formed on the surface of the preform M. Therefore, an adhesion force of the molded object O with respect to the forming mold is reduced, so that it is possible to smoothly remove the molded object O from the forming mold in the cooling process.

Second Annealing Process S4

The second annealing process is a process of eliminating distortion that has occurred in the molded object O after the press molding. In this process, the plurality of molded objects O are mounted on the carriage tray 14A, the carriage tray 14A is housed in the housing portion 131 of the housing box 13, and thereafter the cap portion 132 is closed. Accordingly, the first closed space Sp1 is formed below each of the molded objects O and the second closed space Sp2 is formed above the plurality of molded objects O. Then, an annealing process is performed by heating the molded object O in the housing box 13 at predetermined temperature.

In the second annealing process, the molded object O is heated and thereafter gradually cooled in an air atmosphere, so that distortion of the molded object O is eliminated and a refractive index of the molded object O is returned to a set value. Further, in this process, the molded object O is heated in the air atmosphere, so that an altered layer is formed on an outer side of a standard layer that is made of a normal glass component. The altered layer is, similarly to the protection layer M2 as described above, an oxidized layer that is obtained by oxidization and alteration of the glass component of the molded object O. The altered layer contains, for example, 30% or less fluorine and 30% or more oxygen.

The altered layer is formed by alteration (oxidization) of the glass component in a neighboring region on an inner side of the protection layer M2 that is formed in the first annealing process. The altered layer and the protection layer M2 are layers made of the same component, and therefore, a boundary is not present between the two layers. Therefore, in the present embodiment, as illustrated in FIG. 6, a layer that is formed on an outer side of a standard layer O1 made of a normal glass component and that includes the protection layer M2 formed in the first annealing process and the altered layer formed in the second annealing process is defined as an “oxidized layer O2”. Meanwhile, as described above, while the boundary between the altered layer and the protection layer M2 is not clear, an outermost layer of the oxidized layer O2 corresponds to the protection layer M2 and a layer between the protection layer M2 and the standard layer O1 corresponds to the altered layer in a conceptual sense.

The second annealing process is performed such that, as described above, “the volume of the first closed space Sp1<the volume of the second closed space Sp2”. Therefore, one of two surfaces of the molded object O, on which the altered layer is to be thinly formed, is arranged at the side of the first closed space Sp1, and another surface, on which the altered layer is to be thickly formed, is arranged at the side of the second closed space Sp2.

In the second annealing process, the lower surface of the molded object O reacts with only oxygen in the first closed space Sp1, and the upper surface of the molded object O reacts with only oxygen in the second closed space Sp2. Therefore, as compared to a conventional method in which, for example, the molded object O is subjected to the annealing process in the annealing furnace 1 without being housed in the housing box 13, it is possible to slow down the formation rate of the altered layer. Consequently, in the second annealing process, it is possible to prevent the altered layer from becoming unnecessarily thick, and it is possible to form only a minimum altered layer.

Here, in the conventional method of producing an optical element, an annealing process is not performed before the pressing process, and an annealing process is performed only once in the annealing furnace 1 without putting the molded object O that has been subjected to the pressing process in the housing box 13. In contrast, in the method of producing the optical element according to the embodiment, the annealing processes are performed twice, but the annealing processes are performed while controlling the amount of oxygen that reacts in the closed spaces. Therefore, the thickness of the oxidized layer O2 (a total thickness of the protection layer M2 and the altered layer) that is formed on the surface of the molded object O through the two annealing processes in the method according to the present embodiment is smaller than a thickness of an oxidized layer that is formed on a surface of a molded object through a single annealing process in the conventional method.

Polishing process S5 In the polishing process, the molded object O is polished, so that at least a part of the oxidized layer O2 (see FIG. 6), which includes the protection layer M2 that is formed through the first annealing process and the altered layer that is formed in the neighboring region on the inner side of the protection layer M2, is removed. Meanwhile, a type of an abrasive used in this process is not specifically limited. Further, in this process, it is not necessary to remove the entire oxidized layer O2 that is formed on the surface of the molded object O, but it may be possible to leave the oxidized layer O2 with a certain thickness that does not affect the optical function and the film forming process in the subsequent stage.

Here, the polishing process is performed even in the conventional method of producing an optical element, but because the oxidized layer formed on the surface of the molded object is thick, it takes a long time to polish the molded object. For example, in the conventional production method, the thickness of the oxidized layer after the annealing process is about 0.24 μm, and a polishing time of about 13 minutes per object is needed to remove the oxidized layer. In contrast, in the method of producing the optical element according to the present embodiment, if the same preform M as the conventional one is used, the oxidized layer O2 (the protection layer M2 and the altered layer) after the second annealing process has only a thickness of about 0.12 μm, so that the polishing time can be reduced to a half of the conventional polishing time, that is, reduced to about 6.5 minutes per object.

Film forming process S6 In the film forming process, an antireflection film is formed on the surface of the molded object O. By forming the antireflection film as described above on the surface of the molded object O that is made of the fluorophosphate glass material, it is possible to improve reflectance of the molded object O and protect the surface of the molded object O. In the method of producing the optical element according to the present embodiment, the optical element is produced through the processes as described above.

According to the method of producing the optical element as described above, the preform M that is not yet pressed is heated and the protection layer M2 is formed on the surface of the preform M in the first annealing process, so that it is possible to prevent a defect, such as a crack, at the time of pressing.

Furthermore, in the first annealing process and the second annealing process, the annealing processes are performed on the preform M and the molded object O in the closed space including the first closed space Sp1 and the second closed space Sp2, so that it is possible to slow down the formation rate of the oxidized layer O2 (the protection layer M2 and the altered layer) and it is possible to easily control the thickness of the oxidized layer O2.

Moreover, if a fluorophosphate glass material is heated in an air atmosphere, fluorine on a surface of the material is reduced and oxygen is increased, so that an altered layer (oxidized layer) is formed on the surface. In addition, if an antireflection film is formed while the thick altered layer is remained, reflectance after film formation largely varies. Therefore, the polishing process for polishing and removing the altered layer has been conventionally performed, but there is a problem in that man-hours increase in proportion to the thickness of the altered layer and the specification of reflectance. In contrast, in the second annealing process of the method of producing the optical element according to the present embodiment, it is possible to prevent the altered layer from becoming unnecessarily thick and form only a minimum altered layer, so that it is possible to minimize man-hours of the polishing process.

Furthermore, if heating temperature increases or a heating duration increases in a case in which the first annealing process is performed without putting the preform M in the housing box 13 for example, an external defect, such as a crack, appears on the surface of the preform M. In contrast, if the heating temperature decreases or the heating duration decreases, a protection film with a desired thickness is not formed, so that it becomes impossible to prevent a crack in the pressing process on the subsequent stage. Moreover, if the plurality of annealing furnaces 1 are used for example, there is a mechanical difference among the annealing furnaces 1, so that a difference occurs such that “excessive annealing” occurs in the certain annealing furnace 1 and “insufficient annealing” occurs in another annealing furnace 1.

In contrast, in the method of producing the optical element according to the present embodiment, it is possible to slow down the formation rate of the protection layer M2 and perform appropriate anneal by putting the preform M in the housing box 13, so that it is possible to increase a range of anneal conditions and it is possible to cancel out the mechanical difference between the annealing furnaces 1. Therefore, it is possible to improve a yield rate in production of the molded object O.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of producing an optical element, the method comprising:
heating a preform that is made of a fluorophosphate glass material to alter a region including a surface of the preform to form a protection layer; and
performing press molding on the preform with the formed protection to form a molded object having an optical element shape.

2. The method of producing the optical element according to claim 1, further comprising:
heating the molded object to eliminate distortion of the molded object; and
polishing the heated molded object to remove at least a part of an oxidized layer including the protection layer and an altered layer that is obtained by alteration due to heating of the molded object in a neighboring region on an inner side of the protection layer.

3. The method of producing the optical element according to claim 1, wherein the preform is arranged in a closed space during the heating of the preform.

4. The method of producing the optical element according to claim 3, wherein
the closed space includes
a first closed space that is formed from a first surface of the preform in the closed space; and
a second closed space that is formed from a second surface of the preform in the closed space,
the first closed space is a space with a volume of 10 mm\hat{ }3 or smaller per surface area of 1 mm\hat{ }2 of the first surface of the preform, and
the second closed space is a space with a volume of 600 mm\hat{ }3 per surface area of 1 mm\hat{ }2 of the second surface of the preform.

5. The method of producing the optical element according to claim 2, wherein the molded object is arranged in a closed space during the heating of the molded object.

6. The method of producing the optical element according to claim 5, wherein
the closed space includes
a first closed space that is formed from a first surface of the molded object in the closed space; and
a second closed space that is formed from a second surface of the molded object in the closed space,
the first closed space is a space with a volume of 10 mm\hat{ }3 or smaller per surface area of 1 mm\hat{ }2 of the first surface of the molded object, and
the second closed space is a space with a volume of 600 mm\hat{ }3 per surface area of 1 mm\hat{ }2 of the second surface of the molded object.
